(19) United States
(12) Patent Application Publication
(10) Pub. No.: US 2016/0353935 A1
(43) Pub. Date: Dec. 8, 2016

(54) First slice square and wedge

(71) Applicant: Jeff Abrams, Three Oaks, MI (US)

(72) Inventor: Jeff Abrams, Three Oaks, MI (US)

(21) Appl. No.: 14/545,693

(22) Filed: Jun. 8, 2015

(51) Int. Cl. A47J 43/28

(52) U.S. Cl. CPC A47J 43/288

(57) ABSTRACT

First Slice is a kitchen tool to be paced at the bottom of a pan before building a lasagna, quiche, pie, casserole etc. The tool will facilitate the removal of the first slice neatly and cleanly.

First Slice is a stainless steel kitchen tool to be paced at the inside bottom of a pan before building a lasagna, quiche, pie, casserole etc. The steel is bendable to conform to the slope of the individual pan. There is a removable silicone sleeve on the lifting flange to protect the user from oven heat. After removing the pan from the oven, the user will run the tip of a knife along the bottom of the pan using the edge of First Slice as a guide. The tool will facilitate the removal of the first slice neatly and cleanly without disturbing the adjacent slices.

Included are the following drawings;

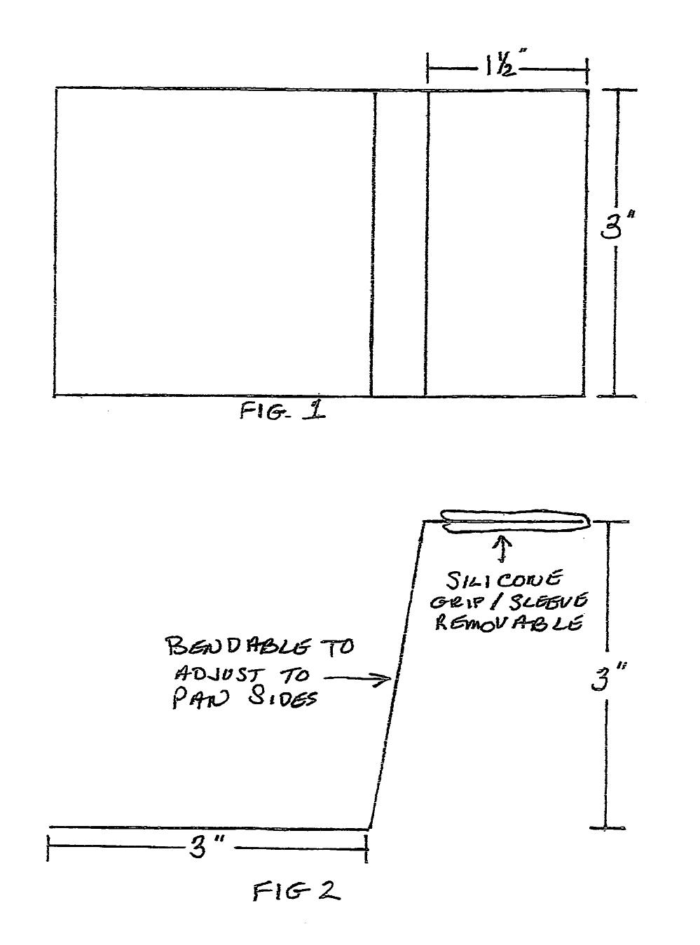

FIG. 1; First Slice Square top view

FIG. 2; First Slice Square side view

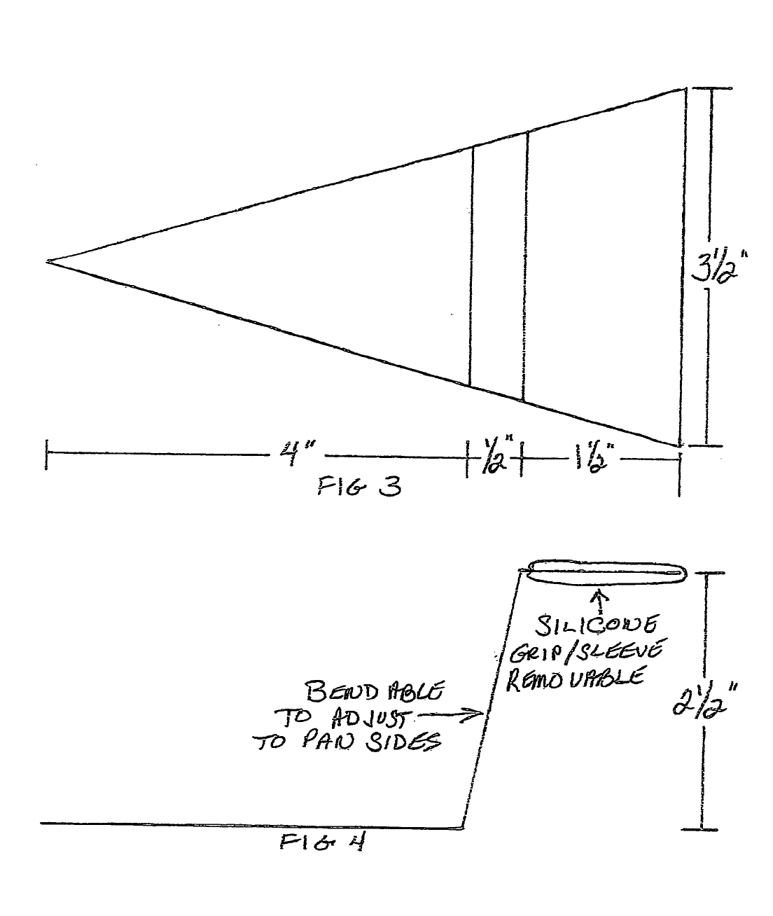

FIG. 3; First Slice Wedge top view

FIG. 4; First Slice Wedge side view

1. “First Slice” is a stainless steel kitchen tool to be (paced) placed at (the) inside bottom of a pan before building a lasagna, quiche, pie, casserole etcetera (The tool will) to facilitate (the) removal of (the) first slice neatly and cleanly without disturbing (the) adjacent slices while protecting the user from oven heat with a lifting flange fitted with a removable silicone sleeve (There is also a removable silicone sleeved on the lifting flange to protect user from oven heat.)
